(19) United States
(12) Patent Application Publication
(10) Pub. No.: US 2015/0348538 A1
(43) Pub. Date: Dec. 3, 2015

(54) SPEECH SUMMARY AND ACTION ITEM GENERATION

(71) Applicant: Thomas Alan Donaldson, Nailsworth (GB)

(72) Inventor: Thomas Alan Donaldson, Nailsworth (GB)

(73) Assignee: AliphCom, San Francisco,, CA (US)

(21) Appl. No.: 14/289,617

(22) Filed: May 28, 2014

(51) Int. Cl. G10L 15/08; G10L 15/26

(52) U.S. Cl. CPC G10L 15/08; G10L 15/26; G10L 2015/088

(57) ABSTRACT

Techniques for generating summaries and action items associated with speech are described. Disclosed are techniques for receiving data representing an audio signal including speech, determining one or more words associated with the speech, determining one or more vocal fingerprints associated with the speech, and identifying a keyword associated with the speech using the one or more words and the one or more vocal fingerprints. Presentation of the keyword may be made at a loudspeaker, a display, another user interface, and the like. A summary, including meta-data and a content summary, may be generated from one or more keywords, and the summary may be presented to a user.

### CROSS REFERENCE TO RELATED APPLICATIONS

This application is related to co-pending U.S. patent application Ser. No. 13/831,301, filed Mar. 14, 2013, entitled “DEVICES AND METHODS TO FACILITATE AFFECTIVE FEEDBACK USING WEARABLE COMPUTING DEVICES,” which is incorporated by reference herein in its entirety for all purposes.

### FIELD

Various embodiments relate generally to electrical and electronic hardware, computer software, human-computing interfaces, wired and wireless network communications, telecommunications, data processing, signal processing, natural language processing, wearable devices, and computing devices. More specifically, disclosed are techniques for generating summaries and action items from an audio signal having speech, among other things.

### BACKGROUND

Conventional natural language processing may perform speech recognition and produce a literal conversion of speech into text. The generated text typically includes non-verbal sounds, such as sounds expressing emotions (e.g., “umm,” “ha,” etc.) To understand the content, a user may need to read all or a large portion of the text. Conventional systems may provide portions of a text and rely on a user to infer a general notion of the text.

Thus, what is needed is a solution for generating summaries and action items from an audio signal having speech.

### BRIEF DESCRIPTION OF THE DRAWINGS

Various embodiments or examples (“examples”) are disclosed in the following detailed description and the accompanying drawings:

FIG. 1 illustrates an example of a speech summary manager implemented on a media device, according to some examples;

FIG. 2 illustrates an example of an application architecture for a speech summary manager, according to some examples;

FIG. 3 illustrates an example of a processing of a speech session based on one or more words and one or more vocal fingerprints, according to some examples;

FIG. 4 illustrates an example of a probability table of acoustic properties and associated sentence meta-data, according to some examples;

FIG. 5 illustrates an example of a probability table of words and associated sentence meta-data and speech meta-data, according to some examples;

FIG. 6 illustrates an example of a probability table of vocal fingerprints and associated sentence meta-data and speech meta-data, according to some examples;

FIG. 7A illustrates examples of a flowchart for determining keywords based on one or more speech parameters, such as word count, vocal fingerprint, acoustic properties, and the like, according to some examples;

FIG. 7B illustrates an example of a flowchart for generating a content summary associated with a speech session based on one or more speech parameters, such as word count, vocal fingerprint, acoustic properties, and the like, according to some examples;

FIG. 8 illustrates an example of a flowchart for generating meta-data associated with a speech session based on one or more speech parameters, such as word count, vocal fingerprint, acoustic properties, and the like, according to some examples;

FIG. 9 illustrates an example of a flowchart for generating action items associated with a speech session based on one or more speech parameters, such as word count, vocal fingerprint, acoustic properties, and the like;

FIG. 10 illustrates an example of a flowchart for implementing a speech summary manager; and

FIG. 11 illustrates a computer system suitable for use with a speech summary manager, according to some examples.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

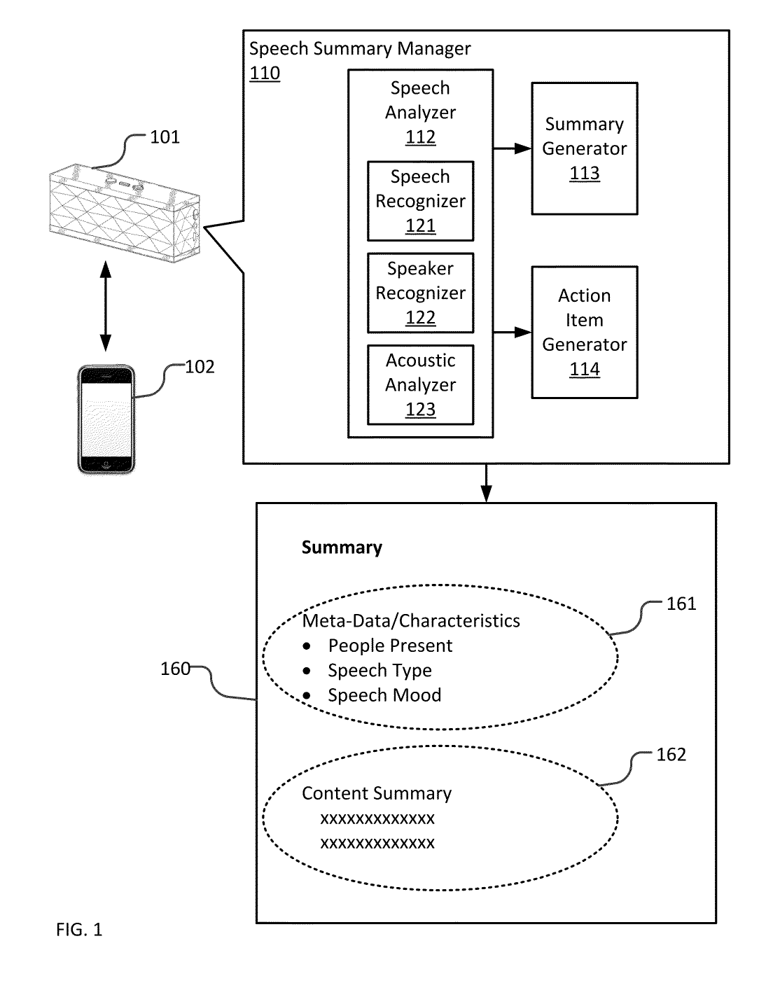

FIG. 1 illustrates an example of a speech summary manager implemented on a media device, according to some examples. As shown, FIG. 1 depicts a media device 101, a smartphone or mobile device 102, a speech summary manager 110, a speech analyzer 112, a speech recognizer 121, a speaker recognizer 122, an acoustic analyzer 123, a summary generator 113, an action item generator 114, and a summary 160 including meta-data or characteristics 161 associated with a speech session, and a content summary 162 associated with the speech session. Speech summary manager 110 may receive data representing an audio signal. The audio signal may include speech. The audio signal may be processed to determine or identify one or more words, vocal fingerprints or biometrics, acoustic properties (e.g., amplitude, frequency, tone, rhythm, etc.), or other parameters associated with the speech or speech session. The processing may be implemented using signal processing, frequency analysis, image processing of a frequency spectrum, speech recognition, speaker recognition, and the like. For example, speech recognizer 121 may determine or recognize the words in the speech. Speaker recognizer 122 may determine or recognize a vocal fingerprint in the speech, and may further identify the identity of a speaker based on the vocal fingerprint. Acoustic analyzer 123 may determine one or more acoustic properties. Using the identified words, vocal fingerprints, acoustic properties, or other parameters, one or more keywords associated with the speech may be identified. A keyword may be a significant word, term (e.g., one or more words), or concept expressed or mentioned in the speech. A keyword may be used as an index to the content of the speech. A keyword may be used to provide a main point or key point of the speech. A keyword may be used to provide a summary or a brief, concise account of the speech, which may enable a reader or user to become acquainted or familiar with the content of the speech without having to listen to its entirety. The keyword may be presented to the user at a user interface, such as at a speaker using an audio signal, a display using a visual signal, through printed braille or braille displays, and the like.

In some examples, summary 160 may be generated by summary generator 113. Summary 160 may include speech meta-data or characteristics 161, such as the people present, the speech type, the speech mood, the duration of the speech session, the date and time of the speech session, whether the speech session started late or on time, and the like. Speech meta-data 161 may be a description, characteristic, or parameter associated with a speech session. Summary 160 may also include a content summary 162 associated with the speech session. Content summary 162 may provide a brief or concise account of the speech session, which may enable a user to know the content or main content of the speech session, without having to listen to the speech session in its entirety. Content summary 162 may include a keyword or key sentence extracted from the speech, paraphrased sentences or paragraphs that summarize the speech, bullet-form points from the speech, and the like. In some examples, one or more action items (not shown) may be generated by action item generator 114. An action item may include an operation or function to be performed by a device as a result of the speech session. An action item may be generating and storing data representing an event or appointment on an electronic calendar, or generating and storing data representing a task on an electronic task list. The electronic calendar or task list may be stored in a memory locally or remotely (e.g., on a server). For example, a portion of speech may indicate that a next meeting is to be set up at a certain future time, and that certain people agree to attend the next meeting. A meeting appointment may be automatically stored in the electronic calendars of those who have agreed to attend. An action item may include other operations as well. For example, a portion of speech may indicate that the speech session is coming to an end. For example, towards the end of a meeting, the speech may include thank you's and farewells. As a meeting ends, an action item may be turning off the lights in the conference room, turning off media device 101 or another device (which may have been used during the meeting), switching a user's smartphone from “Silent” mode to “Ring” mode, and the like.

Speech may include spoken or articulated words, non-verbal sounds such as sounds expressing emotion, hesitation, contemplation, satisfaction (e.g., “umm,” “ha,” “mmm,” etc.), and the like. A speech or speech session may be a continuous or integral series of spoken words and sentences, which may include the voices of one or more people. A speech session may be associated with a variety of purposes, such as, delivering an address to an audience, giving a lecture or presentation, having a discussion, meeting, debate, chat, brainstorming session, and the like. A speech session may be conducted in person, over the telephone, over voice-over-IP, or through other means for transmitting and communicating sound or audio signals. In one example, an audio signal may be received using media device 101, which may be used as a speakerphone. Media device 101 may be used for a conference call, without the need to use a telephone handset. In one example, media device 101 may be a JAMBOX® produced by AliphCom, San Francisco, Calif. Other media devices may be used. A portion of the audio signal may include data received from a microphone coupled to media device 101, which may include the voice or voices of local users engaged in a conference call. Another portion of the audio signal may include data received using telecommunications or other wired or wireless communications (e.g., Bluetooth, Wi-Fi, 3G, 4G, cellular, satellite, etc.), which may include the voice or voices of remote users engaged in a conference call. For example, data representing an audio signal may be received over a telecommunications or cellular network at an antenna coupled to mobile device 102, and then transmitted to media device 101 using wired or wireless communications (e.g., Bluetooth, Wi-Fi, 3G, 4G, etc.). As another example, data representing an audio signal may be received over a telecommunications or other network at an antenna or wire coupled to media device 101, without the use of mobile device 102. A microphone coupled to media device 101 may capture the voice or voices of local users, and a loudspeaker coupled to media device 101 may broadcast the voice or voices of remote users.

Speech summary manager 110 may be implemented on media device 101 (as shown), mobile device 102, a server, or another device, or distributed across any combination of devices. Speech summary manager 110 may process the audio signal (e.g., including speech from the local and remote users) and generate a summary 160 of the conference call. In one example, a conference call may be in progress, and media device 101 may receive data representing a call or dial-in from a user, who may be late to joining the conference call. Before connecting him to the conference call, speech summary manager 110 may provide the tardy user with an option to listen to a summary 160 of what has been discussed in the conference call thus far. Speech summary manager 110 may also present summary 160 on a display, or via another user interface. In another example, speech summary manager 110 may provide a summary 160 of the conference call after it has been completed. In another example, speech summary manager 110 may provide a summary 160 of any kind of speech session, including a lecture, presentation, debate, conversation, monologue, media content, brainstorming session, and the like, which may be conducted partially or wholly in-person or virtually.

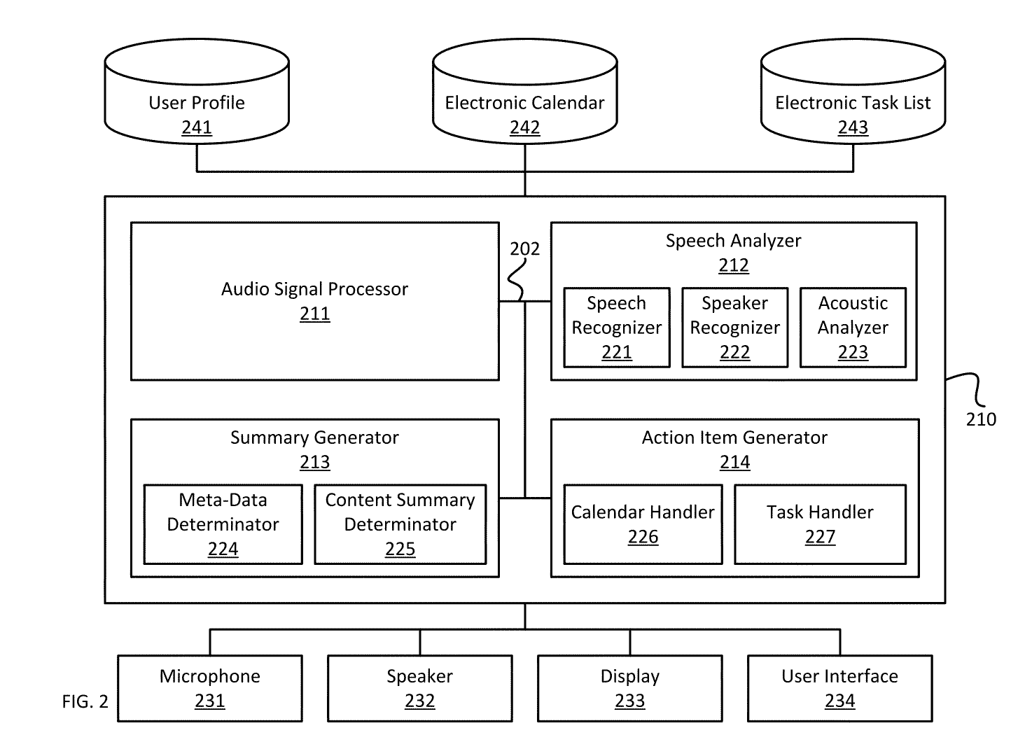

FIG. 2 illustrates an example of an application architecture for a speech summary manager, according to some examples. As shown, FIG. 2 depicts a speech summary manager 210, bus 202, an audio signal processing facility 211, a speech analyzing facility 212, a speech recognition facility 221, a speaker recognition facility 222, an acoustic analysis facility 223, a summary generation facility 213, a meta-data determination facility 224, a content summary determination facility 225, a calendar handler 226, an action item generation facility 214, a calendar handling facility 226, and a task handling facility 227. Speech summary manager 210 may be coupled to a user profile memory or database 241, an electronic calendar memory or database 242, and an electronic task list memory or database 243. Speech summary manager 210 may further be coupled to a microphone 231, a loudspeaker 232, a display 233, and a user interface 234. As used herein, “facility” refers to any, some, or all of the features and structures that may be used to implement a given set of functions, according to some embodiments. Elements 211-214 may be integrated with speech summary manager 210 (as shown) or may be remote from or distributed from speech summary manager 210. Elements 241-243 and elements 231-234 may be local to or remote from speech summary manager 210. For example, speech summary manager 210, elements 241-243, and elements 231-234 may be implemented on a media device or other device, or they may be remote from or distributed across one or more devices. Elements 241-243 and elements 231-234 may exchange data with speech summary manager 210 using wired or wireless communications through a communications facility (not shown) coupled to speech summary manager 210. A communications facility may include a wireless radio, control circuit or logic, antenna, transceiver, receiver, transmitter, resistors, diodes, transistors, or other elements that are used to transmit and receive data from other devices. In some examples, a communications facility may be implemented to provide a “wired” data communication capability such as an analog or digital attachment, plug, jack, or the like to allow for data to be transferred. In other examples, a communications facility may be implemented to provide a wireless data communication capability to transmit digitally-encoded data across one or more frequencies using various types of data communication protocols, such as Bluetooth, ZigBee, Wi-Fi, 3G, 4G, without limitation. A communications facility may be used to receive data representing an audio signal. For example, a communications facility may receive data representing an audio signal through a telecommunications or cellular network during a telephone conference. A communications facility may also be used to exchange other data with other devices.

Audio signal processor 211 may be configured to process an audio signal, which may be received from microphone 231, another microphone, or a communications facility. In some examples, the audio signal may be processed using a Fourier transform, which transforms signals between the time domain and the frequency domain. In some examples, the audio signal may be transformed or represented as a mel-frequency cepstrum (MFC) using mel-frequency cepstral coefficients (MFCC). In the MFC, the frequency bands are equally spaced on the mel scale, which is an approximation of the response of the human auditory system. The MFC may be used in speech recognition, speaker recognition, acoustic property analysis, or other signal processing algorithms. In some examples, audio signal processor 211 may produce a spectrogram of the audio signal. A spectrogram may be a representation of the spectrum of frequencies in an audio or other signal as it varies with time or another variable. The MFC or another transformation or spectrogram of the audio signal may then be processed or analyzed using image processing. In some examples, the audio signals may also be processed or pre-processed for noise cancellation, normalization, and the like.

Speech analyzer 212 may be configured to analyze speech that may be embodied or encoded in the audio signal, which may be processed by audio signal processor 221. Speech analyzer 212 may analyze a MFC representation, spectrogram, or other transformation of the audio signal. Speech analyzer 212 may employ speech recognizer 221, speaker recognizer 222, acoustic analyzer 223, or other facilities, applications, or modules to analyze one or more parameters of the speech. Speech recognizer 221 may be configured to recognize spoken words in a speech or speech session. Speech recognizer 221 may translate or convert spoken words into text. Acoustic modeling, language modeling, hidden Markov models, neural networks, statistically-based algorithms, and other methods may be used by speech recognizer 221. Speech recognizer 221 may be speaker-independent or speaker-dependent. In speaker-dependent systems, speech recognizer 221 may be trained to and learn an individual speaker's voice, and may then adjust or fine-tune algorithms to recognize that person's speech.

Speaker recognizer 222 may be configured to recognize one or more vocal or acoustic fingerprints in speech. A voice of a speaker may be substantially unique due to the shape of his mouth and the way the mouth moves. A vocal fingerprint may be a template or a set of unique characteristics of a voice or sound (e.g., average zero crossing rate, frequency spectrum, variance in frequencies, tempo, average flatness, prominent tones, frequency spikes, etc.). A vocal fingerprint may be used to distinguish one speaker's voice from another's. Speech recognizer 222 may analyze a voice in the speech for a plurality of characteristics, and produce a fingerprint or template for that voice. The audio signal including a voice may be transformed into a spectrogram, which may be analyzed for the unique characteristics of the voice. Speech recognizer 222 may determine the number of vocal fingerprints in a speech or speech session, and may determine which vocal fingerprint is speaking a specific word or sentence within the speech session. Further, a vocal fingerprint may be used to identify an identity of the speaker. A vocal fingerprint may also be used to authenticate a speaker. In one example, user profile database 241 may store one or more user profiles, including the vocal fingerprint templates for one or more users. A vocal fingerprint template may be formed based on previously gathered audio data associated with the speaker's voice, and may include characteristics of the voice. A vocal fingerprint template may be updated or adjusted based on additional audio data associated with that speaker's voice as the audio data is being captured. A user profile may further include other information about the speaker, including the speaker's name, job title, relationship to another user (e.g., spouse, friend, co-worker), gender, age, and the like. Speaker recognizer 222 may compare a vocal fingerprint found in an audio signal with a vocal fingerprint template stored in user profile database 241, and may determine whether the speaker providing the voice in the audio signal is the speaker of vocal fingerprint template.

Acoustic analyzer 223 may be configured to process, analyze, and determine acoustic properties of a speech in an audio signal. Acoustic properties may include an amplitude, frequency, rhythm, and the like. For example, an audio signal of a speaker speaking in a loud voice would have a high amplitude. An audio signal of a speaker asking a question may end in a higher frequency, which may indicate a question mark at the end of a sentence in the English language. An audio signal of a speaker giving a monotonous lecture may have a steady rhythm. Still, other acoustic properties may be analyzed. Speech analyzer 212 may also analyze other parameters associated with the speech. Acoustic analyzer 223 may analyze the acoustic properties of each word, sentence, sound, paragraph, phrase, or section of a speech session, or may analyze the acoustic properties of a speech session as a whole.

Summary generator 213 may be configured to generate a summary of the speech. Summary generator 213 may employ a meta-data determinator 224, a content summary determinator 225, or other facilities or applications. Meta-data determinator 224 may be configured to determine a set of meta-data, or one or more characteristics, associated with the speech or speech session. Meta-data may include the number of people present or participating in the speech session, the identities or roles of those people, the type of the speech session (e.g., lecture, discussion, interview, etc.), the mood of the speech session (e.g., monotonous, exciting, angry, highly stimulating, sad), the duration of the speech session, the time of the speech session, whether the speech session started on time (e.g., according to a schedule or electronic calendar), and the like. Meta-data may be determined based on the words, vocal fingerprints, speakers, acoustic properties, or other parameters determined by speech analyzer 212. For example, speech analyzer 212 may determine that a speech session includes two vocal fingerprints. The two vocal fingerprints alternate, wherein a first vocal fingerprint has a short duration, followed by a second vocal fingerprint with a longer duration. The first vocal fingerprint repeatedly begins sentences with question words (e.g., “Who,” “What,” Where,” “When,” “Why,” “How,” etc.) and ends sentences in higher frequencies. Meta-data determinator 224 may determine that the speech session type is an interview or a question-and-answer session. Still other meta-data may be determined.

Content summary determinator 225 may be configured to generate a content summary of the speech or speech session. A content summary may include a keyword, key sentences, paraphrased sentences of main points, bullet-point phrases, and the like. A content summary may provide a brief account of the speech session, which may enable a user to understand a context, main point, or significant aspect of the speech session without having to listen to the entire speech session or a substantial portion of the speech session. A content summary may be a set of words, shorter than the speech session itself, that includes the main points or important aspects of the speech session. A content summary may be determined based on the words, vocal fingerprints, speakers, acoustic properties, or other parameters determined by speech analyzer 212. For example, based on word counts, and a comparison to the frequency that the words are used in the general English language, one or more keywords may be identified. For example, while words such as “the” and “and” may be the words most spoken in a speech session, their usage may be insignificant compared to how often they are used in the general English language. A keyword may be one or more words. For example, terms such as “paper cut,” “apple sauce,” “mobile phone,” and the like, having multiple words may be one keyword. As another example, based on vocal fingerprints, a voice that dominates a speech session may be identified, and that voice may be identified as a voice of a key speaker. A keyword may be identified based on whether it is spoken by a key speaker. As another example, a keyword may be identified based on acoustic properties or other parameters associated with the speech session. In some examples, a content summary may include a list of keywords. In some examples, sentences around a keyword may be extracted from the speech session, and presented in a content summary. The number of sentences to be extracted may depend on the length of the summary desired by the user. In some examples, sentences from the speech session may be paraphrased, or new sentences may be generated, to include or give context to keywords.

Action item generator 214 may be configured to generate one or more action items or operations based on the speech session. Action item generator 214 may employ a calendar handler 226, a task handler 227, or other facilities or applications. Calendar handler 226 may be configured to generate an event or appointment in an electronic calendar stored in electronic calendar database 242. Task handler 227 may be configured to generate a task in an electronic task list or to-do list stored in electronic task list database 243. An event or task may be determined based on the words, vocal fingerprints, speakers, acoustic properties, or other parameters determined by speech analyzer 212, or the keywords or summary generated by summary generator 213. For example, a speech session may contain a question to set up an appointment spoken by one vocal fingerprint and an affirmative answer spoken by another vocal fingerprint. Calendar handler 226 may generate an appointment based on this discourse. An electronic calendar or electronic task list may be associated with each user or user profile. Still other operations may be performed by other devices. For example, an end of a meeting may be determined based on words such as “Goodbye” and a decreasing number of voices. An action item at the end of a meeting may be to transmit an electronic message or alert (e.g., electronic mail, text message, etc.) to another person to notify him that the meeting is over. An action item may be to turn off the conference room lights, to turn off a media device or other device that was in use during the meeting, and the like. As another example, during a meeting, one participant may state that he needs to provide an update to a person who is not present at the meeting. An electronic message may be automatically sent to the person who is not present, including the content of the update.

User profile memory or database 241, electronic calendar memory or database 242, and electronic task list memory or database 243 may be implemented using various types of data storage technologies and standards, including, without limitation, read-only memory (“ROM”), random access memory (“RAM”), dynamic random access memory (“DRAM”), static random access memory (“SRAM”), static/dynamic random access memory (“SDRAM”), magnetic random access memory (“MRAM”), solid state, two and three-dimensional memories, Flash®, and others. Elements 241-243 may also be implemented on a memory having one or more partitions that are configured for multiple types of data storage technologies to allow for non-modifiable (i.e., by a user) software to be installed (e.g., firmware installed on ROM) while also providing for storage of captured data and applications using, for example, RAM. Elements 241-243 may be implemented on a memory such as a server that may be accessible to a plurality of users, such that one or more users may share, access, create, modify, or use data stored therein.

User interface 234 may be configured to exchange data between speech summary manager 210 and a user. User interface 234 may include one or more input-and-output devices, such as a microphone 231, a loudspeaker 232, a display 233 (e.g., LED, LCD, or other), keyboard, mouse, monitor, cursor, touch-sensitive display or screen, and the like. Microphone 231 may be used to receive an audio signal, which may be processed by speech summary manager 210. Loudspeaker 232, display 233, or other user interface 234 may be used to present a summary or action item. Further, user interface 234 may be used to configure speech summary manager 210, such as adding a user profile to user profile database 241, modifying rules for creating action items, correcting a word that is repeatedly misrecognized by speech recognizer 221, and the like. Still, user interface 234 may be used for other purposes.

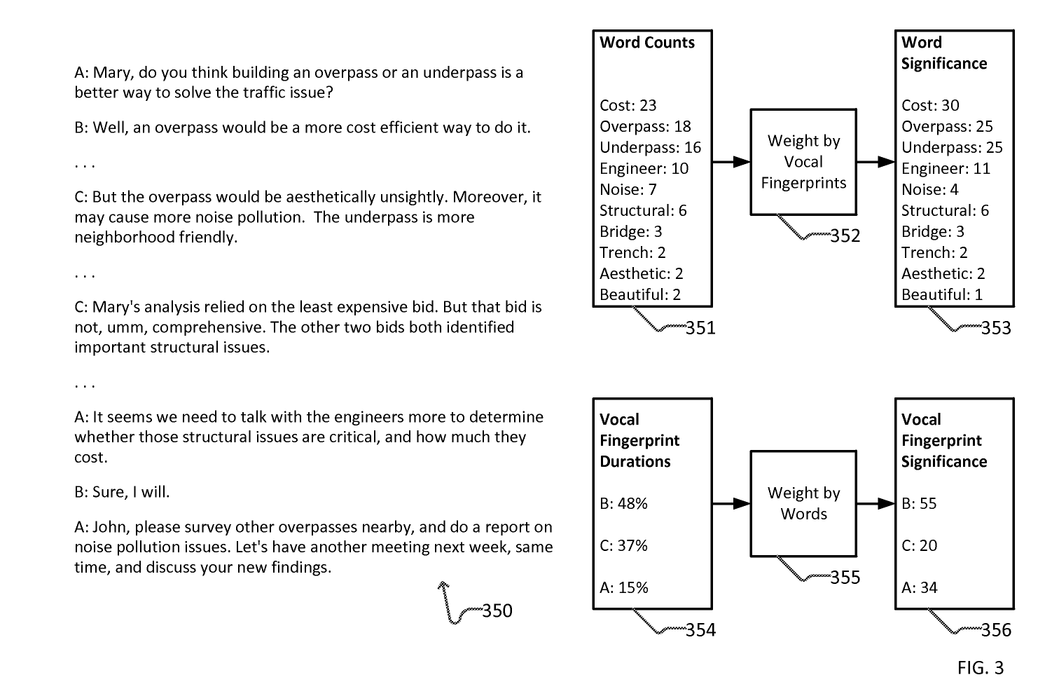

FIG. 3 illustrates an example of a processing of a speech session based on one or more words and one or more vocal fingerprints, according to some examples. As shown, FIG. 3 depicts a partial transcript of a sample speech session 350, a word count list 351, a process for analyzing the words 352, a word significance list 353, a vocal fingerprint duration list 354, a process for analyzing the vocal fingerprints 355, and a vocal fingerprint significance list 356. In some examples, a speech session such as that depicted as partial transcript 350 may be processed by a speech summary manager. Speech summary manager may determine one or more words and vocal fingerprints in the speech session. Speech summary manager may produce a list of word counts 351, which includes a number of times that each word appears in the speech session. Speech summary manager may determine a count of a subset of words that appear in the speech session. As shown, for example, the word “cost” may appear 23 times, and the word “overpass” may appear 18 times. Speech summary manager may also produce a list of vocal fingerprint durations 354, which includes a duration or percentage of time associated with each vocal fingerprint in the speech. Speech summary manager may determine a duration associated with a subset of vocal fingerprints that appear in the speech. As shown, for example, the total time that vocal fingerprint “A” speaks over the total time of the meeting is 0.48 or 48%. In some examples, the word count may be used to determine a level of significance of a word, and the vocal fingerprint duration may be used to determine a level of significance of a vocal fingerprint. For example, the word with the highest count may be the most significant, and may be a keyword. For example, the vocal fingerprint with the highest or longest duration may be the most significant, and may indicate a key speaker. The keyword and key speaker may be presented in a summary.

In other examples, words may be weighted by vocal fingerprints, and vocal fingerprints may be weighted by words. Speech summary manager may determine a significance of a word by assigning weights to words based on vocal fingerprints or other parameters. For example, a word spoken by a vocal fingerprint with a longer duration may be more significant than a word spoken by another vocal fingerprint with a shorter duration. As shown in list 351, for example, the word “noise” may appear 7 times, while the word “structural” may appear 6 times. However, many references to “noise” may be spoken by vocal fingerprint “C” and many references to “structural” may be spoken by vocal fingerprint “B,” wherein vocal fingerprint “B” has a greater duration than vocal fingerprint “C.” Each reference to a word may be weighted higher or more significantly if spoken by vocal fingerprint “B.” Thus, as shown in list 353, for example, the word “structural” may have a significance value of 6, while the word “noise” may have a significance value of 4. Thus, a ranking of keywords may be included in a summary, and “structural” may be a more significant keyword than “noise.” In some examples, a shorter summary may be desired, and a limit may be set on the number of keywords to be used or presented in a summary. In some examples, the word “structural” may be included as a keyword, while the word “noise” may not. Still, other ways to weight the words and word counts using vocal fingerprints may be used. For example, a vocal fingerprint of a speaker with a more senior job title may be associated with a greater weight. In some examples, acoustic properties and other parameters may also be used.

Speech summary manager may determine a significance of a vocal fingerprint by assigning weights to vocal fingerprints based on words mentioned by the vocal fingerprints, or other parameters. As shown in list 354, for example, vocal fingerprint “C” may occupy 37% of the duration of the speech session, while vocal fingerprint “A” may occupy 15%. However, vocal fingerprint “A” may mention or reference more words with a higher count or a higher significance. Each vocal fingerprint may be weighted higher or more significantly if it refers to a word with a higher count or higher significance. Thus, as shown in list 356, for example, vocal fingerprint “C” may have a significance value of 20, while vocal fingerprint “A” may have a significance value of 34. The speaker of vocal fingerprint “A” may be a more important key speaker. A ranking of key speakers may be determined and presented in a summary. A ranking of key speakers may also be used in determining keywords, meta-data associated with the speech, action items, and the like. Still, other ways to weight the vocal fingerprints may be used. In some examples, acoustic properties and other parameters may be used.

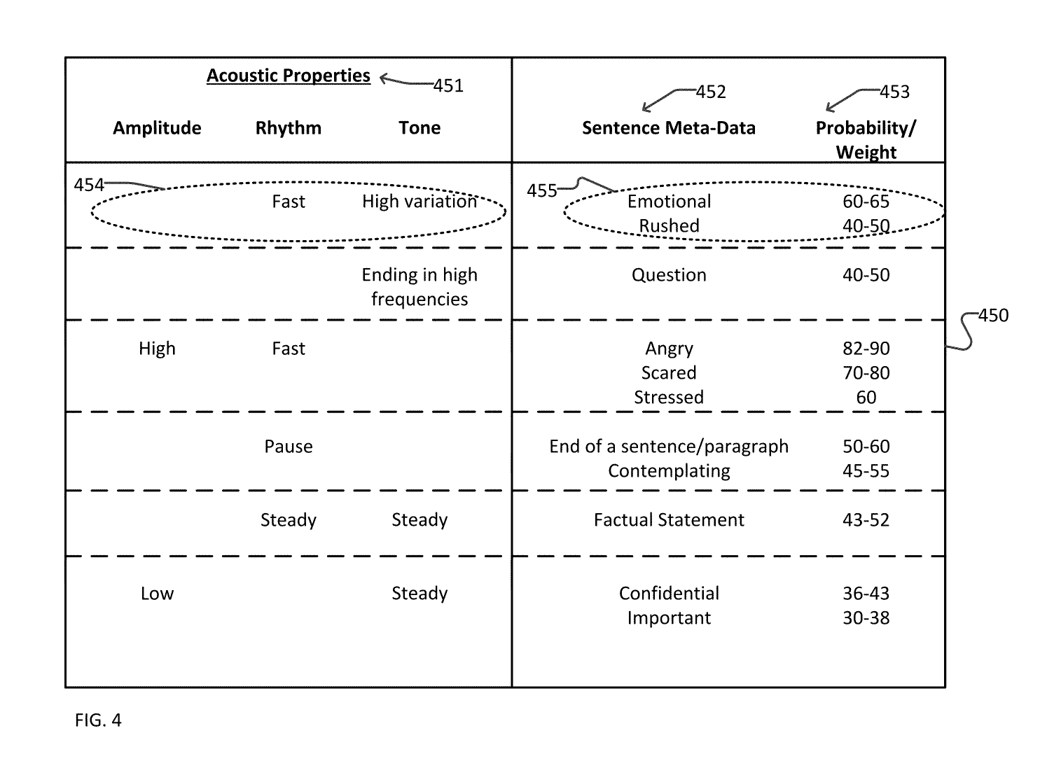

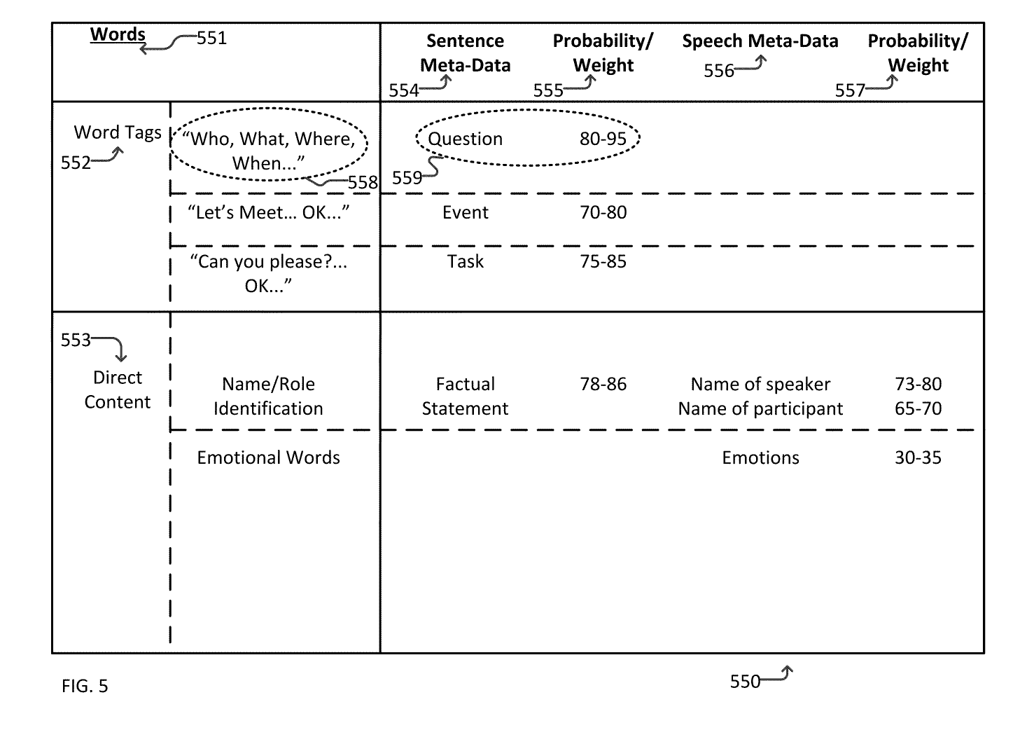

FIG. 4 illustrates an example of a probability table of acoustic properties and associated sentence meta-data, according to some examples. As shown, FIG. 4 depicts a probability table 450 with a list of acoustic properties 451, corresponding to a list of sentence meta-data or characteristics 452 and a list of probabilities or weights 453. Each sentence within a speech session may have different acoustic properties and have different meta-data, such as types, moods, and the like. Examples of acoustic properties 451 include the amplitude, rhythm, and tone of an audio signal or speech. Other acoustic properties 451 may also be used. A sentence meta-data 452 may include the type of sentence (e.g., question, statement, etc.), the emotions involved in the sentence (e.g., highly emotional, angry, sad, etc.), the identity of the speaker of the sentence, and the like. A sentence meta-data 452 may be a description, characteristic, or parameter associated with a sentence. As shown, examples include “Emotional,” “Rushed,” “Question,” “Angry,” “Scared,” “End of a sentence/paragraph,” “Contemplating,” “Factual statement,” “Confidential,” “Important,” and the like. A probability or weight 453 may indicate the likelihood that a set of acoustic properties corresponds to a sentence meta-data. In some examples, probability or weight 453 may be a statistical or mathematical measurement of the likelihood that a sentence having certain acoustic properties actually has certain meta-data or characteristics. In some examples, probability or weight 453 may be used to as a significance or confidence level in whether a sentence having certain acoustic properties actually has a certain meta-data or characteristic. For example, a speech summary manager may determine that one or more characteristics having the highest probabilities/weights are the characteristics of a sentence in a speech session, and present the characteristics of the sentence at a user interface. In other examples, this probability or weight 453 may be combined with probabilities or weights associated with other conclusions drawn from other factors (e.g., speech recognition, speaker recognition, etc.) to make a final determination on the meta-data associated with a sentence. For example, a sentence's acoustic properties may indicate that it is a “question,” with a 40-50 weight, while its words may indicate that it is a “statement” with a 30-40 weight (see, e.g., FIG. 5). Based on the weights, a final determination may be made that the sentence is a “question.”

In a probability table 450, an acoustic property (or a set of acoustic properties) may correspond with one or more sentence meta-data or characteristics, and each sentence meta-data may have a respective weight or indication of likelihood. For example, the first set of acoustic properties 454 may correspond with the first set of meta-data and weights 455. A sentence in a speech session may be determined to have the first set of acoustic properties 454, such as a fast rhythm and high variation in tone, and, based on table 450, it may be determined to have a 60-65 chance of being an “emotional” sentence and a 40-50 chance of being a “rushed” or “hurried” sentence. The probability or weight 453 may indicate that the sentence is more likely to be “emotional” than to be “rushed.” The probability may be adjusted or fine-tuned based on other factors, such as the words and speakers recognized by a speech summary manager. In other examples, a table may indicate a certain acoustic property maps to certain meta-data, and may not use probabilities or weights. In one example, emotional state or mood of a person can be determined as set forth in co-pending U.S. patent application Ser. No. 13/831,301, filed Mar. 14, 2013, entitled “DEVICES AND METHODS TO FACILITATE AFFECTIVE FEEDBACK USING WEARABLE COMPUTING DEVICES,” which is incorporated by reference herein in its entirety for all purposes.

In some examples, table 450 may provide a range of conditions or criteria associated with an acoustic property 451. For example, a “fast” rhythm may be a speed of 150-170 spoken words per minute. For example, a “high variation” in tone may indicate instances in which a change in tone is greater than 1000 Hz per second. Further, in some examples, table 450 may provide a sentence meta-data 452 with a range of probabilities/weights 453. The probability/weight of a certain meta-data being associated with a certain sentence in a speech session may be further narrowed or pinpointed based on acoustic properties of that sentence. For example, a sentence in a speech session may have an acoustic property that is near the upper range of an acoustic property condition in table 450 (e.g., the sentence may have a rhythm of 170 words per minute, which may be the upper range of a “fast” rhythm in table 450). Table 450 may indicate that this acoustic property corresponds to a certain sentence meta-data (e.g., “Rushed”) with a wide range of probabilities/weights (e.g., 40-50). However, since the sentence in the speech session has an acoustic property near the upper range of the acoustic property condition, the range of probabilities/weights associated with this sentence may be narrowed (e.g., narrowed to 43-47).

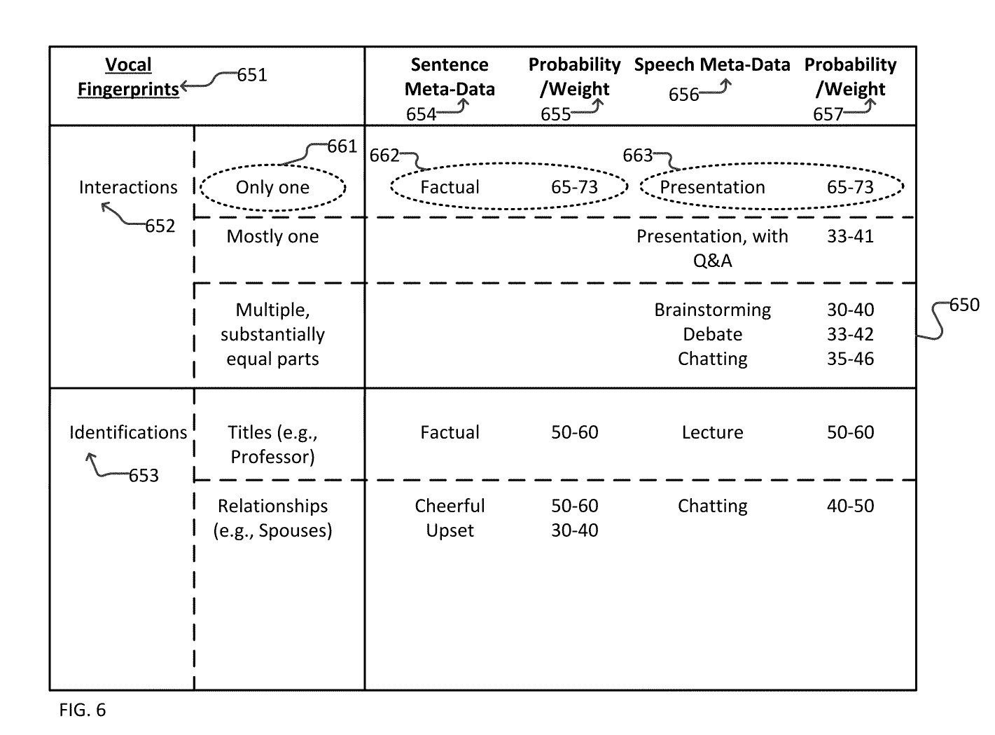

The meta-data and corresponding weights of a sentence in a speech session may also be used in determining a speech meta-data or characteristic. For example, in one speech session, many sentences may have a 60-70 weight of indicating “fear,” while a few sentences may have a 40-50 weight of indicating “anger.” A speech summary manager may determine that the type of this speech session is “expressive,” and the mood of this speech session is “fear.” As another example, in one speech session, many sentences may have a 20-30 weight of indicating “fear,” while a few sentences may have a 70-80 weight of indicating “anger.” Even though there are more sentences indicating “fear,” the sentences indicating “anger” have more weight. Thus, a speech summary manager may determine that the type of this speech session is “expressive,” and the mood of this speech session is “anger.” In some examples, table 450 may include a set of speech meta-data associated with an acoustic property (or a set of acoustic properties). For example, table 450 may indicate that the first set of acoustic properties 454 (e.g., a “fast” rhythm and “high variation” in tone) corresponds with a speech meta-data of being “expressive” (see, e.g., FIGS. 5 and 6).

FIG. 5 illustrates an example of a probability table of words and associated sentence meta-data and speech meta-data, according to some examples. As shown, FIG. 5 depicts a probability table 550, including a list of words or types of words 551, a list of sentence meta-data 554 and probabilities/weights 555, and a list of speech meta-data 556 and probabilities/weights 557. For example, the first set of words or word types 558 (e.g., “Who, What, Where, When . . . ”) may correspond with the first set of sentence meta-data and probabilities/weights 559 (e.g., “Question,” with probability or weight being 80-95).

The list of words or word types 551 may include word tags 552, direct content 553, or other parameters. A word tag 552 may be a word, term, or phrase that serves as a tag, flag, or indicator of a sentence meta-data, type, mood, or the like. For example, words such as “Let's meet . . . ” or “How about next week at . . . ” may indicate that an appointment is being made. For example, affirmative words such as “OK . . . ” or “Sure . . . ” may indicate that an appointment is confirmed. A sentence meta-data may be “Event,” indicating that the sentence is associated with setting up an appointment or event. As another example, words such as “Can you please . . . ?” may indicate that a task is being assigned, and a corresponding sentence meta-data may be “Task.” As shown, for example, sentence meta-data may be a characteristic or parameter of a sentence that is associated with an action type. For example, the sentence meta-data “Event” may trigger or prompt a speech summary manager to generate and store an event in an electronic calendar.

Direct content 553 may refer to instances where the content of a word, phrase, or sentence directly indicates sentence meta-data or speech meta-data. For example, meta-data or characteristics may be extracted from the content of the speech session. For example, a sentence in a speech session may state, “My name is Mary.” A speech summary manager may recognize that a name of a person has been stated. The content of this sentence may be used to identify the speaker of this sentence, another participant in the speech session, or another person. Table 550 may provide that a name spoken in a sentence indicates the name of the speaker, with a 73-80 weight, or the name of another participant, with a 65-70 weight. Other words surrounding the sentence, or other parameters (e.g., vocal fingerprint, acoustic properties, etc.) may be used to adjust the weights associated with each possibility. As another example, a speaker may state, “I am very disappointed.” A speech summary manager may recognize that a type of emotion has been stated. The content of this sentence may be used to identify a speech meta-data, for example, the speech mood is “Disappointment.” In some examples, the direct content of words may be combined with information associated with vocal fingerprints to determine sentence meta-data or speech meta-data. For example, in one speech session, one speaker may state, “I am disappointed,” and his vocal fingerprint may dominate the speech session. A speech summary manager may determine that the speech mood is “Disappointed.” As another example, in another speech session, one speaker may state, “I am disappointed,” and his vocal fingerprint may occupy a very small fraction of the duration of the speech session. A speech summary manager may not make the determination that the speech mood is “Disappointed.” The speech summary manager may determine the speech mood by placing more weight on the words and acoustic properties associated with other vocal fingerprints in the speech session.

FIG. 6 illustrates an example of a probability table of vocal fingerprints and associated sentence meta-data and speech meta-data, according to some examples. As shown, FIG. 6 depicts a probability table 650, having vocal fingerprints or vocal fingerprint types 651, corresponding sentence meta-data 654 and probabilities/weights 655, and corresponding speech meta-data 656 and probabilities/weights 657. In the table 650, a first vocal fingerprint type 661 (e.g., “Only one” vocal fingerprint in a speech session) may correspond with a first sentence meta-data and probabilities/weights 662 (e.g., a “factual” sentence, with weights being 65-73), and a first speech meta-data and probabilities/weights 663 (e.g., a “presentation” speech session, with weights 65-73).

The vocal fingerprints or vocal fingerprint types 651 may include or be associated with interactions 652, identifications 653, and other parameters associated with vocal fingerprints. Interactions 652 may refer to an interaction or interplay amongst one or more vocal fingerprints in a speech session. For example, there may be only one vocal fingerprint in a speech session. There may be multiple vocal fingerprints, but one of them largely dominates. There may be multiple vocal fingerprints, wherein the time occupied by each vocal fingerprint is substantially equal. Or there may be other interactions or combinations. Interactions 652 may be used to determine sentence meta-data and speech meta-data, and in some examples, corresponding probabilities/weights for each. For example, in a speech session where mostly one vocal fingerprint dominates, but there are other vocal fingerprints involved, a speech summary manager may determine that the speech session is likely a “Presentation with a question-and-answer session.” In a speech session where multiple vocal fingerprints have substantially equal parts in a speech session, a speech summary manager may determine that the speech session is likely a “Brainstorming session,” a “Debate,” or a “Chat or Conversation.” Interactions 652 may also be used to determine a role of a speaker or participant in a speech session. For example, a vocal fingerprint that dominates may be a “main speaker,” and a “project lead” for the project under discussion. Interactions 652 may be combined with other factors to determine meta-data. For example, a speaker whose vocal fingerprint has an intermediate level of involvement, and who asks a relatively large number of questions, may be an “overseer” or “supervisor” of the speech session or project.

Identifications 653 may refer to the use of vocal fingerprints to identify the identity of a speaker. As discussed above, one or more user profiles may be stored in a memory or database. A user profile may contain a vocal fingerprint template of a user, along with the user's name, job title, relationships with other users, and other information. A speech summary manager may analyze an audio signal having speech, and determine whether the speech matches a vocal fingerprint template. A match may be determined if there is substantial similarity or a match within a tolerance, or may be determined based on statistical analysis, machine learning, neural networks, natural language processing, and the like. Using the vocal fingerprint template, a speech summary manager may determine the user profile associated with a vocal fingerprint in a speech session. For example, if a vocal fingerprint in a speech session is associated with a speaker who is a professor, a speech summary manager may determine that a sentence type is likely “Factual,” and a speech type is likely a “Lecture.” For example, if a speech session has two vocal fingerprints, which are associated with a husband and a wife, a speech summary manager may determine a speech type is likely a “Chat or Conversation.” Identifications 653 may be combined with other information to determine sentence meta-data and speech meta-data, and in some examples, corresponding probabilities/weights.

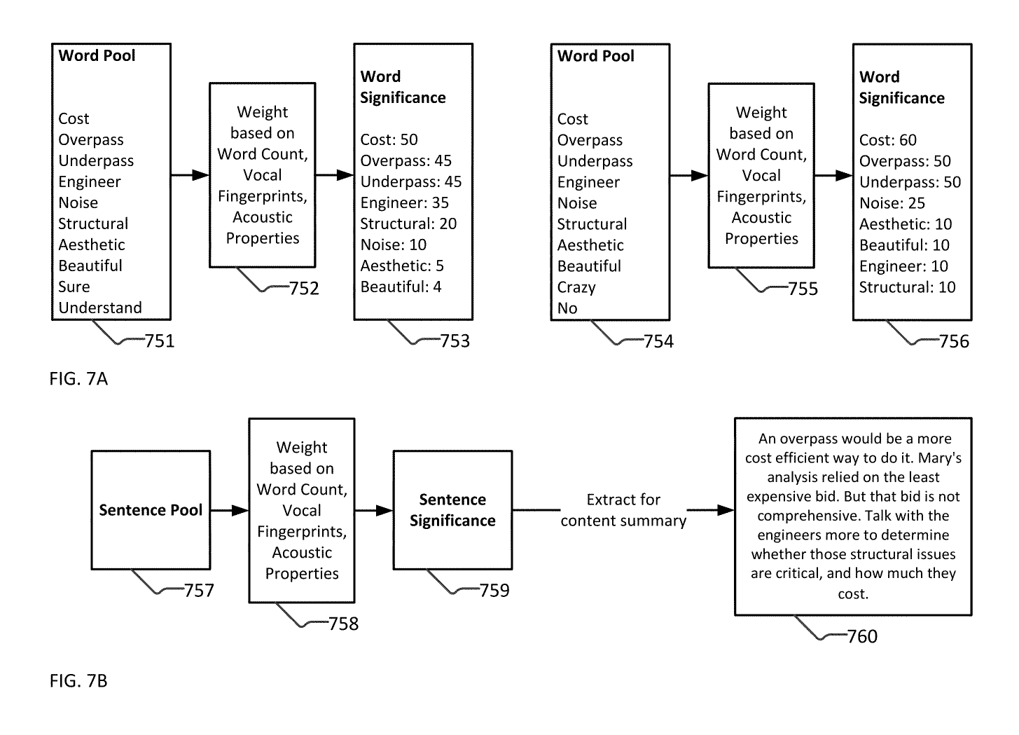

FIG. 7A illustrates examples of a flowchart for determining keywords based on one or more speech parameters, such as word count, vocal fingerprint, acoustic properties, and the like, according to some examples. As shown, FIG. 7A depicts a first word pool 751 corresponding to a first speech session, a weighting process 752, and a first word significance ranking 753. FIG. 7A also depicts a second word pool 754 corresponding to a second speech session, a weighting process 755, and a second word significance ranking 756. A speech recognizer may generate word pools 751 and 754. Weighting processes 752 and 753 may determine the significance of each word in the word pools 751 and 754 based on word counts, vocal fingerprints, acoustic properties, and other parameters. For example, in the first speech session, the most significant words are “Cost,” “Underpass,” “Overpass,” “Engineer,” and “Structural.” These words may be identified as keywords of the first speech session. A summary generated from these keywords may include or focus on the cost and engineering considerations in the underpass/overpass project. For example, in the second speech session, the most significant words are “Cost,” “Underpass,” “Overpass,” “Noise,” “Aesthetics,” and “Beautiful.” A summary generated from these words may include or focus on the aesthetic aspect of the underpass/overpass project. While similar words are included in word pools 751 and 854, the difference in word significance rankings 753 and 756 may be caused by the weighting processes 752 and 755. For example, the first speech session may be a more cordial and professional discussion (e.g., as indicated by words such as, “Sure,” “Understand,” etc.), and the words in word pool 751 may be weighted more by word count and vocal fingerprints. For example, the main speaker may focus on engineering considerations, and engineering considerations may be discussed for a long period of time, which may result in associating the word “Engineer” with a higher significance. For example, the second speech session may be more emotional and highly charged (e.g., as indicated by words such as “Crazy,” “No,” etc.), and the words in word pool 755 may be weighted more by acoustic properties. For example, an angry speaker may focus on aesthetics, and more weight may be given to the speech of an emotional speaker. Thus, the word “aesthetics” may be associated with a higher significance. Sentence meta-data and speech meta-data may also be used to assign weights to words.

In some examples, a speech summary manager may recognize or identify different words with similar or related meanings. For example, a speech session may include the words “beautiful” and “beautifully,” and a speech summary manager may determine that there is a word count of “2” for the word “beautiful.” As another example, a speech session may include the words “aesthetics” and “beautiful.” A speech summary manager may determine that these words relate to a similar concept. Thus, while a word count for “aesthetics” and “beautiful” may individually not be high, the word “aesthetics” may still be given high significance or determined to be a keyword, and may be included in a summary.

FIG. 7B illustrates an example of a flowchart for generating a content summary associated with a speech session based on one or more speech parameters, such as word count, vocal fingerprint, acoustic properties, and the like, according to some examples. As shown, FIG. 7B depicts a sentence pool 757, a weighting process 758, a sentence significance ranking 759, and a summary 760. Based on a word significance ranking, a speech summary manager may extract all or a subset of sentences that include one or more of the words of high significance. A speech summary manager may extract sentences that include one or more keywords. The sentences may be weighted by importance based on word counts, vocal fingerprints, acoustic properties, or other parameters. For example, sentence meta-data and speech meta-data may be determined based on word counts, vocal fingerprints, acoustic properties, or other parameters. Sentence meta-data and speech meta-data may be used to determine an importance of a sentence. For example, a sentence that includes non-verbal or non-word expressions of doubt (e.g., “umm,” etc.) and acoustic properties indicating doubt may be determined to be less significant. For example, in a speech session that is determined to be an interview, sentences that are factual statements may be more significant than sentences that are questions. Further, in some examples, a speech summary manager may remove non-verbal expressions (e.g., “umm,” “mmm,” “ha,” etc.) from extracted sentences. As shown, for example, summary 760 may be generated from the speech session depicted in FIG. 3 (element 350). Summary 760 may contain extracted sentences that include keywords from the speech session, and may remove non-verbal expressions.

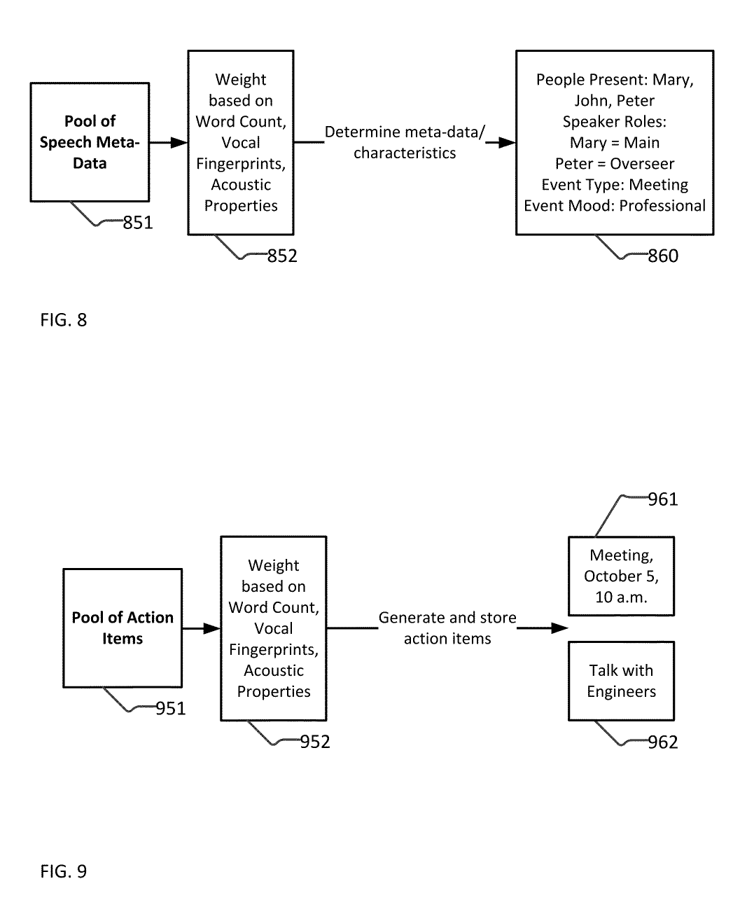

FIG. 8 illustrates an example of a flowchart for generating meta-data associated with a speech session based on one or more speech parameters, such as word count, vocal fingerprint, acoustic properties, and the like, according to some examples. As shown, FIG. 8 depicts a pool of speech meta-data 851, a weighting process 852, and a list of speech meta-data to be used in a summary 860. The pool of speech meta-data 851 may be generated from tables associating words, vocal fingerprints, acoustic properties, or other parameters with speech meta-data (such as those depicted in FIGS. 4-6). For example, a table associating words with speech meta-data may indicate that the speech session is a “lecture,” with 80% probability. A table associating vocal fingerprints with speech meta-data may indicate that the speech session is a “question-and-answer session,” with 75% probability. A table associating acoustic properties with speech meta-data may indicate that the speech session is “calm” and “factual.” The pool of speech meta-data 851 may be generated by a speech analyzer, which may implement a speech recognizer, a speaker recognizer, an acoustic analyzer, and other modules or applications. The meta-data may be weighted by how strongly the speech parameters (e.g., words, vocal fingerprints, acoustic properties, etc.) correspond with the templates or conditions listed in the tables, by the importance of each speech parameter, by the confidence level associated with a finding that a speech session has a certain characteristic, and the like. A list of meta-data with the highest significance or highest likelihood or confidence level may be presented in a summary at a user interface. As shown, for example, the speakers in the speech session may be identified by name, and their roles in the speech session may be determined (e.g., “Main speaker,” “Overseer of the discussion,” etc.). An event type (e.g., “Meeting”) and event mood (e.g., “Professional”) may be determined. Still other meta-data or characteristics may be determined.

FIG. 9 illustrates an example of a flowchart for generating action items associated with a speech session based on one or more speech parameters, such as word count, vocal fingerprint, acoustic properties, and the like. As shown, FIG. 9 depicts a pool of action items 951, a weighting process 952, and action items 961 and 962. The pool of action items 951 may be generated based from tables associating words, vocal fingerprints, acoustic properties, or other parameters with speech meta-data, including action items (such as those depicted in FIGS. 4-6). The pool of action items 951 may be generated by a speech analyzer, which may implement a speech recognizer, a speaker recognizer, an acoustic analyzer, and other modules or applications. Action items may be weighted based on word counts, vocal fingerprints, acoustic properties, and the like. For example, a key speaker (e.g., having a dominating vocal fingerprint) may provide speech that indicates an action item. For example, the key speaker may state, “Please meet me next week at 10 a.m. at my office,” and the acoustic properties may indicate that this sentence is a “factual statement” or a “command or request.” This sentence may prompt action item 961 to be generated. A speech summary manager may cause data representing an event to be stored in an electronic calendar, which may be stored in a local or remote memory. The electronic calendar may be associated with the speaker. The data representing the event may include a time, place, location, topic, subject, notes, attendees, and the like. In some examples, a speech summary manager may store an event in an electronic calendar belonging to the person to whom the speaker was speaking (e.g., the person who received the request, “Please meet me next week at 10 a.m. at my office”). In some examples, data representing a task 962 may be stored in an electronic task list. The data representing the task may include a deadline, a submission method, topic, subject, notes, persons responsible, and the like. As another example, a speaker may state, “I wish that you would get me a coffee.” This speaker may have a junior job title, and the keywords associated with the speech session may be unrelated to “coffee.” While the pool of action items 951 may include a task to buy coffee, the weighting process 952 may determine that this task is not important or not likely to be a task. Thus, a speech summary manager may not store a task to buy coffee on an electronic task list. Still, other action items may be performed or executed. The speech summary manager may be in data communication with a plurality of devices, and the speech summary manager may cause one or more devices to perform or execute an operation based on a speech session.

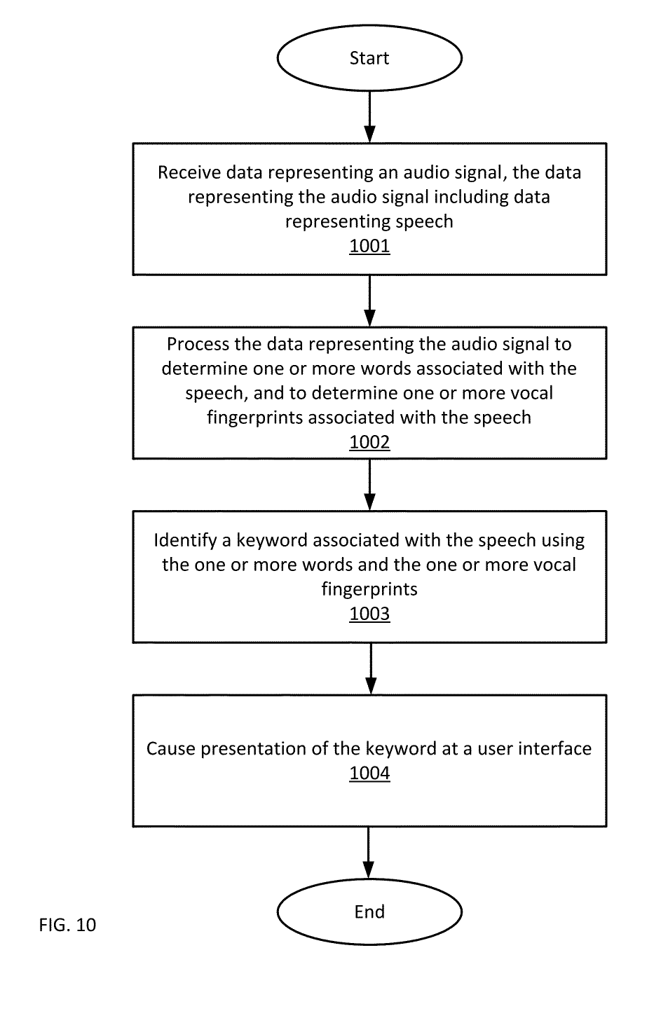

FIG. 10 illustrates an example of a flowchart for implementing a speech summary manager. At 1001, data representing an audio signal may be received. The data representing the audio signal may include data representing speech. The data representing the audio signal may be associated with a telephone conference. The data representing an audio signal may be received at a microphone that is local to or remote from the speech summary manager. A portion of the data representing the audio signal may be received from a local microphone, while another portion may be received from a remote microphone. The speech may include verbal and non-verbal (e.g., non-words) speech. The speech may form a speech session, which may be a continuous or integral series of spoken words or sounds. The speech session may be a meeting, a presentation, a monologue, a conversation, and the like. At 1002, the data representing the audio signal may be processed to determine one or more words associated with the speech and to determine one or more vocal fingerprints associated with the speech. The data representing the audio signal may be processed to determine a spectrogram, a MFC representation, or other transformation of the audio signal. The spectrogram or transformation may undergo image processing or other processing methods. Speech recognition and speaker recognition algorithms may be used. At 1003, a keyword associated with the speech may be identified using the one or more words and the one or more vocal fingerprints. A keyword may be a word of most significance or high significance. A keyword may be used to enable a user to understand a main point of a speech session without having to listen to the speech session. A keyword may be determined by assigning weights words referenced in the speech based on word counts, vocal fingerprint durations, acoustic properties, and other parameters, and determining a significance of a word. The significance of a vocal fingerprint may also be determined based on word counts and other parameters, and the significance of a vocal fingerprint may in turn affect the significance of a word. The keyword may be used to form a summary of the speech session. At 1004, presentation of the keyword at a user interface may be caused. The user interface may be a loudspeaker, a display, or the like. In one example, the speech session may be a telephone conference, and a caller may join the conference after it has been in progress. Before connecting the caller to the conference, a speech summary manager may present the summary or keyword to the caller. The summary or keyword may be presented using a loudspeaker local to the caller, which may be remote from the speech summary manager. In some examples, the summary may be presented in another form, such as braille, or another language, which may assist persons with disabilities or language difficulties in understanding the main points of a speech session.

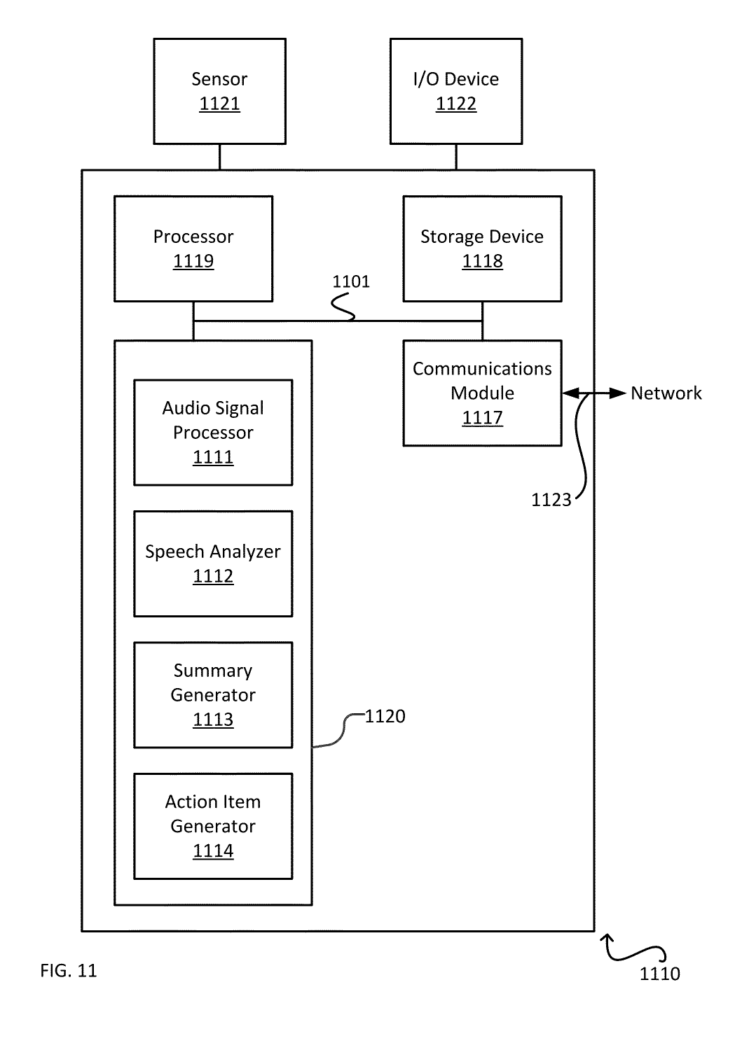

FIG. 11 illustrates a computer system suitable for use with a speech summary manager, according to some examples. In some examples, computing platform 1110 may be used to implement computer programs, applications, methods, processes, algorithms, or other software to perform the above-described techniques. Computing platform 1110 includes a bus 1101 or other communication mechanism for communicating information, which interconnects subsystems and devices, such as processor 1119, system memory 1120 (e.g., RAM, etc.), storage device 1118 (e.g., ROM, etc.), a communications module 1117 (e.g., an Ethernet or wireless controller, a Bluetooth controller, etc.) to facilitate communications via a port on communication link 1123 to communicate, for example, with a computing device, including mobile computing and/or communication devices with processors. Processor 1119 can be implemented with one or more central processing units (“CPUs”), such as those manufactured by Intel® Corporation, or one or more virtual processors, as well as any combination of CPUs and virtual processors. Computing platform 1110 exchanges data representing inputs and outputs via input-and-output devices 1122, including, but not limited to, keyboards, mice, audio inputs (e.g., speech-to-text devices), speakers, microphones, user interfaces, displays, monitors, cursors, touch-sensitive displays, LCD or LED displays, and other I/O-related devices. An interface is not limited to a touch-sensitive screen and can be any graphic user interface, any auditory interface, any haptic interface, any combination thereof, and the like. Computing platform 1110 may also receive sensor data from sensor 1121, including a heart rate sensor, a respiration sensor, an accelerometer, a motion sensor, a galvanic skin response (GSR) sensor, a bioimpedance sensor, a GPS receiver, and the like.

According to some examples, computing platform 1110 performs specific operations by processor 1119 executing one or more sequences of one or more instructions stored in system memory 1120, and computing platform 1110 can be implemented in a client-server arrangement, peer-to-peer arrangement, or as any mobile computing device, including smart phones and the like. Such instructions or data may be read into system memory 1120 from another computer readable medium, such as storage device 1118. In some examples, hard-wired circuitry may be used in place of or in combination with software instructions for implementation. Instructions may be embedded in software or firmware. The term “computer readable medium” refers to any tangible medium that participates in providing instructions to processor 1119 for execution. Such a medium may take many forms, including but not limited to, non-volatile media and volatile media. Non-volatile media includes, for example, optical or magnetic disks and the like. Volatile media includes dynamic memory, such as system memory 1120.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 1101 for transmitting a computer data signal.

In some examples, execution of the sequences of instructions may be performed by computing platform 1110. According to some examples, computing platform 1110 can be coupled by communication link 1123 (e.g., a wired network, such as LAN, PSTN, or any wireless network) to any other processor to perform the sequence of instructions in coordination with (or asynchronous to) one another. Computing platform 1110 may transmit and receive messages, data, and instructions, including program code (e.g., application code) through communication link 1123 and communication interface 1117. Received program code may be executed by processor 1119 as it is received, and/or stored in memory 1120 or other non-volatile storage for later execution.

In the example shown, system memory 1120 can include various modules that include executable instructions to implement functionalities described herein. In the example shown, system memory 1120 includes audio signal processing module 1111, speech analyzing module 1112, summary generation module 1113, and action item generation module 1114.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed:

1. A method, comprising:
receiving data representing an audio signal including speech;
determining one or more words associated with the speech;
determining one or more vocal fingerprints associated with the speech;
identifying a keyword associated with the speech using the one or more words and the one or more vocal fingerprints; and
causing presentation of the keyword.

2. The method of claim 1, further comprising:
determining one or more acoustic properties associated with the speech; and
identifying the keyword associated with the speech using the one or more acoustic properties.

3. The method of claim 2, wherein the one or more acoustic properties comprises at least one of an amplitude, a tone, and a rhythm.

4. The method of claim 1, further comprising:
determining a duration associated with each of a subset of the one or more vocal fingerprints;
determining a level of significance of each of the subset of the one or more vocal fingerprints based on the duration; and
identifying the keyword associated with the speech using the level of significance of each of the subset of the one or more vocal fingerprints.

5. The method of claim 4, further comprising:
determining a count associated with each of a subset of the one or more words;
determining a level of significance of each of the subset of the one or more words based on the count and the duration associated with each of the subset of the one or more vocal fingerprints; and
identifying the keyword associated with the speech using the significance of each of the subset of the one or more words.

6. The method of claim 1, further comprising:
assigning a weight to each of a subset of the one or more words using the one or more vocal fingerprints;
identifying a plurality of keywords based on the weight;
generating a summary using the plurality of keywords; and
presenting the summary.

7. The method of claim 1, further comprising:
identifying a meta-data associated with the speech using the one or more words and the one or more vocal fingerprints.

8. The method of claim 1, further comprising:
determining a first meta-data and a first weight associated with the first meta-data using the one or more words;
determining a second meta-data and a second weight associated with the second meta-data using the one or more vocal fingerprints;
determining a third meta-data using the first weight associated with the first meta-data and the second weight associated with the second meta-data;
generating a summary using the third meta-data; and
presenting the summary.

9. The method of claim 1, further comprising:
determining a user profile of a speaker using one of the one or more vocal fingerprints; and
identifying the keyword associated with the speech using the user profile of the speaker.

10. The method of claim 1, further comprising:
determining an acoustic property associated with one of the one or more vocal fingerprints; and
identifying a role of a speaker associated with the one of the one or more vocal fingerprints using the acoustic property.

11. The method of claim 1, further comprising:
identifying a sentence associated with the keyword; and
causing presentation of the sentence at the user interface.

12. The method of claim 1, further comprising:
receiving data representing a call; and
causing presentation of the keyword at a loudspeaker,
wherein the data associated with the audio signal is associated with a telephone conference.

13. The method of claim 1, further comprising:
identifying an event expressed in the speech using the one or more words and the one or more vocal fingerprints;
causing storage of data representing the event at an electronic calendar at a memory.

14. The method of claim 1, further comprising:
identifying a task expressed in the speech using the one or more words and the one or more vocal fingerprints;
causing storage of data representing the task at an electronic task list at a memory.

15. A method, comprising:
receiving data representing an audio signal associated with a speech session from a microphone coupled to a media device;
receiving data representing an incoming call from another device;
determining one or more words associated with the speech session;
determining one or more vocal fingerprints associated with the speech session;
generating a summary associated with the speech session using the one or more words and the one or more vocal fingerprints; and
causing presentation of the summary at a loudspeaker coupled to the another device.

16. The method of claim 15, further comprising:
receiving data representing another audio signal associated with the speech session from a communications facility coupled to the media device.

17. The method of claim 15, further comprising:
determining one or more acoustic properties associated with the speech session; and
generating the summary associated with the speech session using the one or more acoustic properties.

18. The method of claim 15, further comprising:
determining a duration associated with each of a subset of the one or more vocal fingerprints;
determining a level of significance of each of the subset of the one or more vocal fingerprints based on the duration;
identifying a keyword associated with the speech session using the level of significance of each of the subset of the one or more vocal fingerprints; and
generating the summary using the keyword.

19. The method of claim 18, further comprising:
determining a count associated with each of a subset of the one or more words;
determining a level of significance of each of the subset of the one or more words based on the count and the duration associated with each of the subset of the one or more vocal fingerprints; and
identifying the keyword associated with the speech session using the level of significance of each of the subset of the one or more words.

20. The method of claim 15, further comprising:
identifying a meta-data associated with the speech session using the one or more words and the one or more vocal fingerprints.
